(19) United States
(12) Patent Application Publication
(10) Pub. No.: US 2005/0273186 A1
(43) Pub. Date: Dec. 8, 2005

(54) Optical sensor, printing station and printing method

(75) Inventors: Ian Morris, Belper (GB); James Neil Elliott, Chelmsford (GB); David John Perry, Hainault (GB)

Correspondence Address: SHOEMAKER AND MATTARE, LTD, 10 POST OFFICE ROAD - SUITE 110, SILVER SPRING, MD, 20910, US

(73) Assignee: Neopost Industrie SA, Bagneux (FR)

(21) Appl. No.: 10/768,711

(22) Filed: Feb. 2, 2004

(30) Foreign Application Priority Data
Jan. 31, 2003 (GB) 0302273.8

(51) Int. Cl. G05B 19/18

(52) U.S. Cl. 700/59

(57) ABSTRACT

An optical sensor for sensing items transported along an item transport path, comprising: a transmitter element for transmitting a sensing beam to a detection location, which sensing beam interacts with each item as transported through the detection location; a receiver element for sensing the sensing beam at the detection location and outputting an output signal; and a processor unit for receiving the output signal of the receiver element and performing a determination based upon the same.

### FIELD OF THE INVENTION

The present invention relates to an optical sensor, and a printing station for and a method of printing indicia on items, in particular postage indicia on mail items.

### BACKGROUND OF THE INVENTION

Currently, optical sensors are used in many applications. One application is the sensing of the transport of items beyond a predetermined position, such as in mail handling apparatus for sensing the transport of mail items beyond a predetermined position, which event is utilized to actuate a device, such as a printing device for printing indicia.

Existing optical sensors suffer, however, from the particular problem that the transmitter and receiver elements, typically photodiodes, as used in such optical sensors have widely varying characteristics, such that each pair of transmitter and receiver elements has different threshold characteristics. Thus, average threshold values for item present and item absent have to be set. In having to set average threshold values, such sensors can be prone falsely to sense mail items when mail items are not present or not sense mail items when mail items are present.

This problem associated with existing optical sensors can at least partially be overcome by utilizing high-specification transmitter and receiver elements which have a much-reduced tolerance in the operating characteristics, but such transmitter and receiver elements are more expensive, and such sensors hence are of considerably higher cost.

This problem associated with existing optical sensors can also be overcome by matching the transmitter and receiver elements, and calibrating the matched pairs, but again this matching and calibration is a time-consuming, and hence expensive, process, leading to sensors of considerably higher cost. This approach can also cause problems with both service and repair, as any replacement element must be similarly selected and calibrated.

It is an aim of the present invention to provide an optical sensor which avoids the need for high-specification components and time-consuming fabrication.

It is a further aim of the present invention to provide an optical sensor which provides for the reading of control codes, typically one-dimensional barcodes, on items, in particular mail items, as transported thereby, and an item handling system incorporating the same.

It is a still further aim of the present invention to provide a printing station for and a method of printing indicia on items in accordance with control codes applied thereto, where the control codes include indicia information.

### SUMMARY OF THE INVENTION

In one aspect the present invention provides an optical sensor for sensing items transported along an item transport path, comprising: a transmitter element for transmitting a sensing beam to a detection location, which sensing beam is reflected by each item as transported through the detection location; a receiver element for sensing the reflected sensing beam and outputting an output signal; and a processor unit for receiving the output signal of the receiver element and identifying a control code comprising at least one element, where present on an item, from the output signal, wherein the output signal has a first, element background value defined by a background reflectance of the respective item at the control code and a second, element sensed value defined by a reflectance of the at least one element of the control code.

Preferably, the at least one element of the control code is identified by reference to a previously-determined element sensed threshold value as determined from one or both of previously-determined element background and element sensed values.

In one embodiment the at least one element of the control code is identified by reference to an element sensed threshold value as determined from one or both of the element background and element sensed values of the previous item.

In another embodiment the at least one element of the control code is identified by reference to an element sensed threshold value as determined from one or both of the element background and element sensed values of the first item of a batch of items.

In a further embodiment the at least one element of the control code is identified by reference to an element sensed threshold value as determined from one or both of the element background and element sensed values of the current item.

In yet another embodiment the at least one element of the control code is identified by reference to an element sensed threshold value as determined from one or both of the element background and element sensed values of ones of the previous items.

Preferably, the control code is a one-dimensional barcode comprising a plurality of spaced elements.

In one embodiment at least ones of the items each include a printed control code.

In one embodiment at least ones of the items each include a label bearing the control code.

The present invention also extends to an item handling system including the above-described sensor.

Preferably, the items comprise mail items, such as letters and parcels.

In another aspect the present invention provides an optical sensor for sensing items transported along an item transport path, comprising: a transmitter element for transmitting a sensing beam to a detection location, which sensing beam interacts with each item as transported through the detection location; a receiver element for sensing the sensing beam at the detection location and outputting an output signal; and a processor unit for receiving the output signal of the receiver element and determining, for each item, a position of a leading edge of the item from the output signal, where the output signal has at least a first, item background value when no item is at the detection location and a second, item sensed value when the item is at the detection location.

Preferably, the leading edge of the item is identified by reference to a previously-determined item sensed threshold value as determined from one or both of previously-determined item background and item sensed values.

In one embodiment the leading edge of the item is identified by reference to an item sensed threshold value as determined from one or both of the item background and item sensed values of the previous item.

In another embodiment the leading edge of the item is identified by reference to an item sensed threshold value as determined from one or both of the item background and item sensed values of the first item of a batch of items.

In a further embodiment the leading edge of the item is identified by reference to an item sensed threshold value as determined from one or both of the item background and item sensed values of the current item.

In yet another embodiment the leading edge of the item is identified by reference to an item sensed threshold value as determined from one or both of the item background and item sensed values of ones of the previous items.

Preferably, the sensor is configured as a reflectance sensor, with the sensing beam as transmitted by the transmitter element being reflected by each item as transported through the detection location, and the receiver element sensing the reflected sensing beam.

Preferably, the processor unit is further configured to identify a control code comprising at least one element, where present on an item, from the output signal, wherein the output signal has a first, element background value defined by a background reflectance of the respective item at the control code and a second, element sensed value defined by a reflectance of the at least one element of the control code.

Preferably, the at least one element of the control code is identified by reference to a previously-determined element sensed threshold value as determined from one or both of previously-determined element background and element sensed values.

In one embodiment the at least one element of the control code is identified by reference to an element sensed threshold value as determined from one or both of the element background and element sensed values of the previous item.

In another embodiment the at least one element of the control code is identified by reference to an element sensed threshold value as determined from one or both of the element background and element sensed values of the first item of a batch of items.

In a further embodiment the at least one element of the control code is identified by reference to an element sensed threshold value as determined from one or both of the element background and element sensed values of the current item.

In yet another embodiment the at least one element of the control code is identified by reference to an element sensed threshold value as determined from one or both of the element background and element sensed values of ones of the previous items.

Preferably, the control code is a one-dimensional barcode comprising a plurality of spaced elements.

In one embodiment at least ones of the items each include a printed control code.

In one embodiment at least ones of the items each include a label bearing the control code.

The present invention also extends to an item handling system including the above-described sensor.

Preferably, the items comprise mail items, such as letters and parcels.

In a further aspect the present invention provides an item printing station, comprising: an item transport path along which items are transported, where at least ones of the items have a control code applied thereto, which control codes include indicia information utilized at least in part in generating printed indicia; an optical sensor for reading control codes, where present, on items transported along the item transport path; and a printing unit disposed downstream of the sensor for printing indicia on items, where, for each item having an applied control code, the indicium is generated at least in part utilizing the indicium information in the control code.

Preferably, the sensor is further configured to sense a position of each item in the item transport path, and the printing unit is configured to print an indicium on a respective item in response to sensing the position of the same.

Preferably, the items comprise mail items, such as letters and parcels.

In one embodiment the indicium information defines a service, such as class, registered, recorded or insured.

In another embodiment the indicium information defines a weight.

In a further embodiment the indicium information defines a postage value for the indicium.

In yet another aspect the present invention provides a method of printing indicia on items, comprising the steps of: transporting items along an item transport path, where at least ones of the items have a control code applied thereto; for each item having a control code applied thereto, reading the applied control codes; determining indicia information from the control codes; and printing indicia on items, where, for each item having an applied control code, the indicium is generated at least in part utilizing the indicium information in the control code.

Preferably, the method further comprises the step of: sensing a position of each item in the item transport path, whereby an indicium is printed on a respective item in response to sensing the position of the same.

Preferably, the items comprise mail items, such as letters and parcels.

In one embodiment the indicium information defines a service, such as class, registered, recorded or insured.

In another embodiment the indicium information defines a weight.

In a further embodiment the indicium information defines a postage value for the indicium.

### BRIEF DESCRIPTION OF THE DRAWINGS

Preferred embodiments of the present invention will now be described hereinbelow by way of example only with reference to the accompanying drawings, in which:

FIG. 1 illustrates an optical sensor for sensing the transport of items thereby in accordance with a preferred embodiment of the present invention;

FIG. 2 represents an output signal from the optical sensor unit of the optical sensor of FIG. 1 for a mail item having a plain surface;

FIG. 3 represents an output signal from the optical sensor unit of the optical sensor of FIG. 1 for a mail item having a control code applied thereto; and

FIG. 4 illustrates a mail printing station in accordance with a preferred embodiment of the present invention.

### DETAILED DESCRIPTION OF THE PREFERRED EMBODIMENTS

FIG. 1 illustrates an optical sensor 1 in accordance with a preferred embodiment of the present invention.

The optical sensor 1, in this embodiment a reflectance sensor, comprises an optical sensor unit 2 which comprises a transmitter element 3 for transmitting a sensing beam to a detection location L, and a receiver element 5 for sensing the sensing beam as reflected by items 7 transported past the detection location L.

The optical sensor 1 further comprises a processor unit 9 for receiving an output signal S from the receiver element 5 and providing a control signal CS representative of the output signal S. In this embodiment the processor unit 9 can identify the transport of items 7 past the detection location L and read control codes 11, typically one-dimensional barcodes comprising a plurality of spaced elements, on transported items 7. Where the items 7 are mail items, it is envisaged that the control codes 11 would be pre-printed or applied thereto, for example, by printing or on labels.

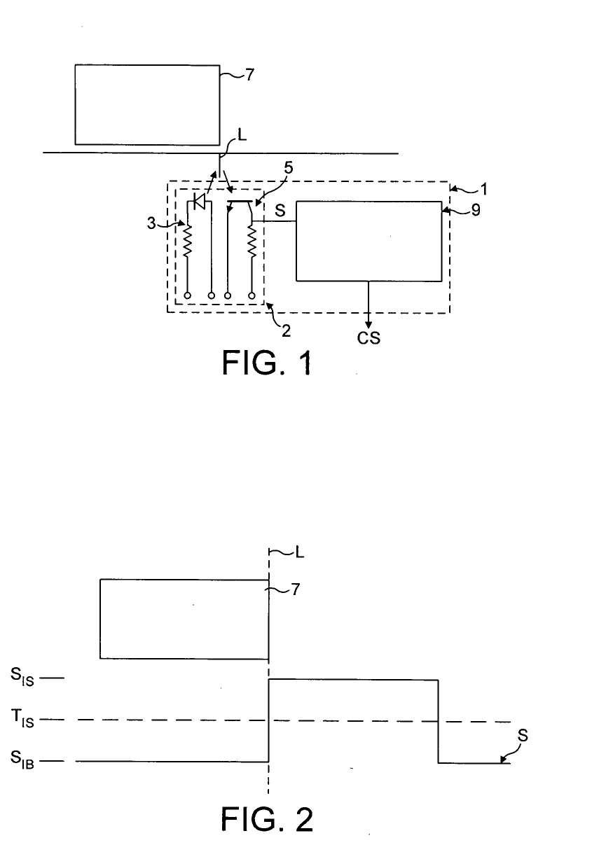

FIG. 2 illustrates a typical output signal S for an item 7 having a plain surface of a predetermined reflectance. As will be seen, until the item 7 reaches the detection location L, the output signal S from the receiver element 5 is at a first, item background value S_{IB}, and, while the item 7 is passing over the detection location L, the output signal S from the receiver element 5 is at a second, item sensed value S_{IS}.

The processor unit 9 is operative to derive an item sensed threshold value T_{IS} which is a threshold value which, when first exceeded by the value of the output signal S, as resulting from the receiver element 5 receiving the sensing beam as reflected by the item 7, causes the generation of an item present control signal CS_{IP} which is utilized to indicate the location of the leading edge of the item 7 at the detection location L, and, when the output signal S falls below the item sensed threshold value T_{IS} from the item sensed value S_{IS}, causes the generation of an item absent control signal CS_{IA}. The item present control signal CS_{IP} is ordinarily utilized to actuate a device which operates on the item 7, for example, a printing device in printing on the item 7, and the item absent control signal CS_{IA} is utilized to prevent the device from operating when the item 7 has passed thereby, for example, to prevent printing beyond the trailing edges of items 7.

In one embodiment the item sensed threshold value T_{IS} is a previously-derived value which is derived from one or both of a previously-determined item sensed value S_{IS} and a previously-determined item background value S_{IB}. In being determined from an output signal S of the receiver element 5, the item sensed threshold value T_{IS} is a value specific to the optical sensor unit 2 and not an average value for that kind of optical sensor unit 2, and, in being a value specific to the optical sensor unit 2, the optical sensor unit 2 provides for self-calibration and minimizes false detection.

In one particular embodiment the item sensed threshold value T_{IS} can be derived from the output signal S from the previous item 7 transported through the optical sensor 1. In this way, small batches of items 7 having the same reflectance characteristics can be accommodated, as, following transport of the first item 7 in a batch, the remaining items 7 will have the same characteristics, and thus the derived item sensed threshold value T_{IS} will be an optimal value for the remaining items 7.

In another particular embodiment the item sensed threshold value T_{IS} can be derived from the output signals S from ones of the previous items 7, thereby representing a best-fit value, for example, an average value. Where items 7 of a certain kind are routinely utilized, the derived item sensed threshold value T_{IS} will be an optimal value for the items 7 which are routinely used.

In one embodiment, particularly where relatively large batches of items 7 are handled at a time, the item sensed threshold value T_{IS} can ordinarily be a first-derived value, typically a best-fit value, but, where a predetermined number of items 7 having the same reflectance, and hence substantially the same item sensed value S_{IS}, are successively handled, the item sensed threshold value T_{IS} can instead be derived from the output signal S from at least ones of the predetermined number of items 7.

In another embodiment, particularly where the optical sensor 1 is utilized to actuate another device, for example, a printing device, downstream of the optical sensor 1 and thereby with a time delay relative to the leading edge of the item 7 passing the detection location L, the item sensed threshold value T_{IS} can be derived during capture of the output signal S for the item 7. In one mode, by determining that the output signal S has another steady-state value, in this embodiment an item sensed value S_{IS} for a predetermined period of time, the item sensed threshold value T_{IS} is derived from one or both of the item sensed value S_{IS} and the item background value S_{IB}. In being determined from an output signal S from the receiver element 5, the item sensed threshold value T_{IS} is a value specific to the optical sensor 1 and not an averaged value for that kind of optical sensor 1, and, in being a value specific to the optical sensor 1, the optical sensor 1 provides for self-calibration and minimizes false detection.

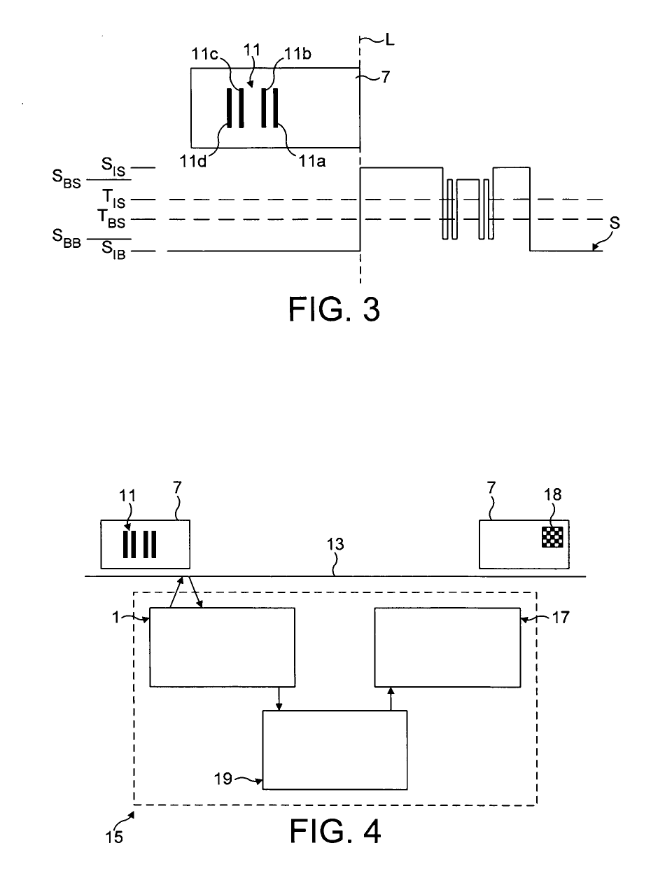

FIG. 3 illustrates a typical output signal S for an item 7 of a predetermined reflectance having a control code 11, here a one-dimensional barcode, thereon.

As will be seen, until the item 7 reaches the detection location L, the output signal S is at a first, item background value S_{IB}, and, when the item 7 reaches and passes over the detection location L, the output signal S increases to an item sensed value S_{IS}. The output signal S remains at the item sensed value S_{IS} until the leading edge of the barcode 11 reaches the detection location L, at which point the output signal S decreases to a second, barcode background value S_{BB} for the period of the first bar element 11a of the barcode 11, and subsequently increases to a barcode sensed value S_{BS} for the period of the space between the first and second bar elements 11a, 11b of the barcode 11, with this transition between the barcode background value S_{BB} and the barcode sensed value S_{BS} repeating for each of the bar elements 11b, 11c, 11d and the spaces of the barcode 11. When the barcode 11 passes beyond the detection location L, the output signal S increases to the item sensed value S_{IS}, and, while the remainder of the item 7 is passing over the detection location L, the output signal S remains at the item sensed value S_{IS}. In this embodiment the barcode background value S_{BB} has a higher value than the item background value S_{IB} as the optical sensor unit 2 has a predetermined imaging width which is such as to overlap a respective bar element 11a, 11b, 11c, 11d and adjacent space at the leading and trailing edges of the bar elements 11a, 11b, 11c, 11d of the barcode 11, and thereby provides for a higher background intensity, with the reflectance of an overlapped space adding to the reflected intensity. Likewise, in this embodiment the barcode sensed value S_{BS} has a lower value than the item sensed value S_{IS} as the imaging width of the optical sensor unit 2 is such as to overlap a respective bar element 11a, 11b, 11c, 11d and adjacent space at the leading and trailing edges of the bar elements 11a, 11b, 11c, 11d of the barcode 11, and thereby provides for a lower background intensity, with the reduced reflectance of an overlapped bar element 11a, 11b, 11c, 11d reducing the reflected intensity.

The processor unit 9 is operative to derive a barcode sensed threshold value T_{BS} which is a threshold value which is utilized to determine the widths of the bar elements 11a, 11b, 11c, 11d and the spaces therebetween of a barcode 11 on an item 7, with the leading edge of a bar element 11a, 11b, 11c, 11d being identified when the value of the output signal S falls below the barcode sensed threshold value T_{BS} and the trailing edge of a bar element 11a, 11b, 11c, 11d being identified when the value of the output signal S exceeds the barcode sensed threshold value T_{BS}.

In one embodiment the barcode sensed threshold value T_{BS} is a previously-derived value which is derived from one or both of a previously-determined barcode sensed value S_{BS} and a previously-determined barcode background value S_{BB}. In being determined from an output signal S from the receiver element 5, the barcode sensed threshold value T_{BS} is a value specific to the optical sensor unit 2 and not an averaged value for that kind of optical sensor unit 2, and, in being a value specific to the optical sensor unit 2, the optical sensor unit 2 provides for self-calibration and minimizes false detection.

In one particular embodiment the barcode sensed threshold value T_{BS} can be derived from the output signal S from the previous item 7 transported through the optical sensor 1. In this way, small batches of items 7 having the same reflectance characteristics can be accommodated, as, following transport of the first item 7 in a batch, the remaining items 7 will have the same characteristics, and thus the derived barcode sensed threshold value T_{BS} will be an optimal value for the remaining items 7.

In another particular embodiment the barcode sensed threshold value T_{BS} can be derived from the output signals S from ones of the previous items 7, thereby representing a best-fit value, for example, an average value. Where items 7 of a certain kind are routinely utilized, the derived barcode sensed threshold value T_{BS} will be an optimal value for the items 7 which are routinely used.

In one embodiment, particularly where relatively large batches of items 7 are handled at a time, the barcode sensed threshold value T_{BS} can ordinarily be a first-derived value, typically a best-fit value, but, where a predetermined number of items 7 having the same reflectance, and hence substantially the same barcode sensed value S_{BS}, are successively handled, the barcode sensed threshold value T_{BS} can instead be derived from the output signal S from at least ones of the predetermined number of items 7.

In another embodiment, particularly where the optical sensor 1 is utilized to actuate another device, for example, a printing device, downstream of the optical sensor 1 and thereby with a time delay relative to the leading edge of the item 7 passing the detection location L, the barcode sensed threshold value T_{BS} can be derived from the captured output signal S from the receiver element 5. The barcode sensed threshold value T_{BS} is derived from one or both of the barcode sensed value S_{BS} and the barcode background value S_{BB}. In being determined from an output signal S from the receiver element 5, the barcode sensed threshold value T_{BS} is a value specific to the optical sensor unit 2 and not an averaged value for that kind of optical sensor unit 2, and, in being a value specific to the optical sensor unit 2, the optical sensor unit 2 provides for self-calibration and minimizes false detection.

The determined configuration of the barcode 11, that is, the widths of the bar elements 11a, 11b, 11c, 11d and the spaces of the barcode 11, is compared to the configuration of stored barcodes which each represent a particular required action regarding the item 7, and the optical sensor 1 outputs an action control signal CS_{An} representative of the action required for the item 7.

In operation, the processing unit 9 identifies a barcode 11 on an item 7 from the output signal S of the receiver element 5, and outputs an action control signal CS_{An} representative of the action required for the item 7.

FIG. 4 schematically illustrates a mail printing station 15 in accordance with a preferred embodiment of the present invention.

The mail printing station 15 comprises a mail transport path 13 along which mail items 7 are transported, the optical sensor 1 as above-described for sensing the transport of mail items 7 along the mail transport path 13, a printing unit 17 disposed downstream of the optical sensor 1 for printing postage indicia 18 on mail items 7, and a control unit 19 for controlling the printing unit 17 in response to control signals CS as generated by the optical sensor 1, where the control signals CS include item present and item absent control signals CS_{IP}, CS_{IA} which identify the leading and trailing edges of a mail item 7 to set the commencement and termination of the printing of a postage indicium 18 and an action control signal CS_{An} which identifies at least one postage characteristic, for example, the service level, such as class, registered, recorded, insured, etc, and weight, as designated by a barcode 11, which postage characteristic in part determines the postage indicium 18 to be applied to the mail item 7. In this embodiment a barcode 11 is applied to one side of a mail item 7 and the postage indicium 18 is applied to the other side of the mail item 7.

Where the items 7 are mail items, the barcodes 11 would typically indicate the service to be applied to the mail items 7, which service determines the postage charge and the form of the printed postage indicia 18. By way of example, typical services represented by barcodes 11 could include first class mail (barcode #1), second class mail (barcode #2), parcel mail (barcode #3) and first class registered mail (barcode #4), and the optical sensor 1 would output a corresponding action control signal CS₁₋₄. In one embodiment barcodes 11 are pre-printed on the mail items 7. In another embodiment barcodes 11 are printed on labels which are applied to mail items 7. In a further embodiment barcodes 11 can be printed contemporaneously on mail items 7.

Finally, it will be understood that the present invention has been described in its preferred embodiments and can be modified in many different ways without departing from the scope of the invention as defined by the appended claims.

In one alternative embodiment the optical sensor 1 could be a transmission sensor, with the transmitter and receiver elements 3, 5 of the optical sensor unit 2 being disposed to opposed sides of the transport path of the items 7.

1. An optical sensor for sensing items transported along an item transport path, comprising:
a transmitter element for transmitting a sensing beam to a detection location, which sensing beam is reflected by each item as transported through the detection location;
a receiver element for sensing the reflected sensing beam and outputting an output signal; and
a processor unit for receiving the output signal of the receiver element and identifying a control code comprising at least one element, where present on an item, from the output signal, wherein the output signal has a first, element background value defined by a background reflectance of the respective item at the control code and a second, element sensed value defined by a reflectance of the at least one element of the control code.

2. The sensor of claim 1, wherein the at least one element of the control code is identified by reference to a previously-determined element sensed threshold value as determined from one or both of previously-determined element background and element sensed values.

3. The sensor of claim 1, wherein the at least one element of the control code is identified by reference to an element sensed threshold value as determined from one or both of the element background and element sensed values of the previous item.

4. The sensor of claim 1, wherein the at least one element of the control code is identified by reference to an element sensed threshold value as determined from one or both of the element background and element sensed values of the first item of a batch of items.

5. The sensor of claim 1, wherein the at least one element of the control code is identified by reference to an element sensed threshold value as determined from one or both of the element background and element sensed values of the current item.

6. The sensor of claim 1, wherein the at least one element of the control code is identified by reference to an element sensed threshold value as determined from one or both of the element background and element sensed values of ones of the previous items.

7. The sensor of claim 1, wherein the control code is a one-dimensional barcode comprising a plurality of spaced elements.

8. The sensor of claim 1, wherein at least ones of the items each include a printed control code.

9. The sensor of claim 1, wherein at least ones of the items each include a label bearing the control code.

10. An item handling system including the sensor of claim 1.

11. The system of claim 10, wherein the items comprise mail items, such as letters and parcels.

12. An optical sensor for sensing items transported along an item transport path, comprising:
a transmitter element for transmitting a sensing beam to a detection location, which sensing beam interacts with each item as transported through the detection location;
a receiver element for sensing the sensing beam at the detection location and outputting an output signal; and
a processor unit for receiving the output signal of the receiver element and determining, for each item, a position of a leading edge of the item from the output signal, where the output signal has at least a first, item background value when no item is at the detection location and a second, item sensed value when the item is at the detection location.

13. The sensor of claim 12, wherein the leading edge of the item is identified by reference to a previously-determined item sensed threshold value as determined from one or both of previously-determined item background and item sensed values.

14. The sensor of claim 12, wherein the leading edge of the item is identified by reference to an item sensed threshold value as determined from one or both of the item background and item sensed values of the previous item.

15. The sensor of claim 12, wherein the leading edge of the item is identified by reference to an item sensed threshold value as determined from one or both of the item background and item sensed values of the first item of a batch of items.

16. The sensor of claim 12, wherein the leading edge of the item is identified by reference to an item sensed threshold value as determined from one or both of the item background and item sensed values of the current item.

17. The sensor of claim 12, wherein the leading edge of the item is identified by reference to an item sensed threshold value as determined from one or both of the item background and item sensed values of ones of the previous items.

18. The sensor of claim 12, where configured as a reflectance sensor, with the sensing beam as transmitted by the transmitter element being reflected by each item as transported through the detection location, and the receiver element sensing the reflected sensing beam.

19. The sensor of claim 18, wherein the processor unit is further configured to identify a control code comprising at least one element, where present on an item, from the output signal, wherein the output signal has a first, element background value defined by a background reflectance of the respective item at the control code and a second, element sensed value defined by a reflectance of the at least one element of the control code.

20. The sensor of claim 19, wherein the at least one element of the control code is identified by reference to a previously-determined element sensed threshold value as determined from one or both of previously-determined element background and element sensed values.

21. The sensor of claim 19, wherein the at least one element of the control code is identified by reference to an element sensed threshold value as determined from one or both of the element background and element sensed values of the previous item.

22. The sensor of claim 19, wherein the at least one element of the control code is identified by reference to an element sensed threshold value as determined from one or both of the element background and element sensed values of the first item of a batch of items.

23. The sensor of claim 19, wherein the at least one element of the control code is identified by reference to an element sensed threshold value as determined from one or both of the element background and element sensed values of the current item.

24. The sensor of claim 19, wherein the at least one element of the control code is identified by reference to an element sensed threshold value as determined from one or both of the element background and element sensed values of ones of the previous items.

25. The sensor of claim 19, wherein the control code is a one-dimensional barcode comprising a plurality of spaced elements.

26. The sensor of claim 19, wherein at least ones of the items each include a printed control code.

27. The sensor of claim 19, wherein at least ones of the items each include a label bearing the control code.

28. An item handling system including the sensor of claim 19.

29. The system of claim 28, wherein the items comprise mail items, such as letters and parcels.

30. An item printing station, comprising:
an item transport path along which items are transported, where at least ones of the items have a control code applied thereto, which control codes include indicia information utilized at least in part in generating printed indicia;
an optical sensor for reading control codes, where present, on items transported along the item transport path; and
a printing unit disposed downstream of the sensor for printing indicia on items, where, for each item having an applied control code, the indicium is generated at least in part utilizing the indicium information in the control code.

31. The printing station of claim 30, wherein the sensor is further configured to sense a position of each item in the item transport path, and the printing unit is configured to print an indicium on a respective item in response to sensing the position of the same.

32. The printing station of claim 30, wherein the items comprise mail items, such as letters and parcels.

33. The printing station of claim 32, wherein the indicium information defines a service, such as class, registered, recorded or insured.

34. The printing station of claim 32, wherein the indicium information defines a weight.

35. The printing station of claim 32, wherein the indicium information defines a postage value for the indicium.

36. A method of printing indicia on items, comprising the steps of:
transporting items along an item transport path, where at least ones of the items have a control code applied thereto;
for each item having a control code applied thereto, reading the applied control codes;
determining indicia information from the control codes; and
printing indicia on items, where, for each item having an applied control code, the indicium is generated at least in part utilizing the indicium information in the control code.

37. The method of claim 36, further comprising the step of:
sensing a position of each item in the item transport path, whereby an indicium is printed on a respective item in response to sensing the position of the same.

38. The method of claim 36, wherein the items comprise mail items, such as letters and parcels.

39. The method of claim 38, wherein the indicium information defines a service, such as class, registered, recorded or insured.

40. The method of claim 38, wherein the indicium information defines a weight.

41. The method of claim 38, wherein the indicium information defines a postage value for the indicium.
